(19) United States
(12) Patent Application Publication
(10) Pub. No.: US 2011/0108788 A1
(43) Pub. Date: May 12, 2011

(54) Corner Brace for an Enclosure

(76) Inventor: Jill Plumb, Woodland, CA (US)

(21) Appl. No.: 12/614,965

(22) Filed: Nov. 9, 2009

(51) Int. Cl. E04H 17/16; F16M 13/00; B23P 11/00

(52) U.S. Cl. 256/25; 248/351; 29/428

(57) ABSTRACT

A corner brace for use in constructing a planter or enclosure is provided. In the preferred embodiment of the invention the corner brace comprises a first vertical plate, second vertical plate, transverse connecting bottom plate, and a bracket-forming internal support structure. In use, each corner brace supports and restricts the ends of at least two sidewalls of a planter or enclosure. A first sidewall is supported between the first vertical plate and one side of the internal support structure. A second sidewall is supported between the second vertical plate and a second side of said internal support structure. Preferably, the sidewalls comprise a resilient yet slightly flexible material such as wood, recycled plastic lumber or other similar materials. The bottom plate of the corner brace may comprise an anchor hole through which a stake may be threaded through and into the ground, further stabilizing the corner brace and keeping it from being slowly pushed away from the center of the planter by the pressure of the material therein.

### FIELD OF THE INVENTION

The present invention generally relates to enclosures, and more specifically to a corner brace for use in creating enclosures and planter boxes for use in gardening and other applications.

### BACKGROUND OF THE INVENTION

In both inside and outside applications, enclosures serve a myriad of purposes. More specifically, planter boxes (hereinafter “planters”) are used extensively to grow a wide variety of plants in a wide variety of locations.

Planters offer several advantages over traditional in-ground gardening. Planters can be moved or replanted to suit the season, and can be situated anywhere there is sufficient space. Because the soil environment provided is partially or completely separated from the environment on which the planter is placed, the planter environment can be tailored to suit the needs of specific plants. For instance, plants not suited to the local soil could be successfully cultivated in a planter with properly modified soil. Planters offer both flexibility and creativity to a gardener and are a popular addition to houses, apartments, and commercial spaces. Because of these advantages planters are a popular addition to the gardens of many consumers.

Planters and enclosures, such as those above typically holding soil or dirt, as well as those that may be used to contain rock, sand, toys or myriad other things, generally suffer from some common limitations and shortcomings. Planters and enclosures are frequently available in only a limited selection of standard sizes, which limits the spaces in which they may be used and the storage and containment options they provide. Further, planters and enclosures which are fully assembled before shipping or transport are large and cumbersome, while planters or enclosures that are not fully assembled before shipping or transport can suffer from lack of structural integrity or difficulty of assembly. These shipping and transport issues are exacerbated in larger size planters or enclosures, which suffer to a greater extent the problems of being both difficult and expensive to ship fully assembled, or being difficult to assemble or flimsy once assembled. Another shortcoming of current enclosure or planter designs is that due to the above mentioned issues, large planters or enclosures are difficult for a user to assemble, transport or move, and are frequently very expensive.

It is a therefore a first objective of the present invention to provide a standard size corner brace for use in the construction of enclosures or planters that may be constructed to a variety of sizes, shapes, and configurations.

It is a further objective of the present invention to provide a corner brace for use in the constructions of enclosures and planters that is simple, of low cost, and that is interchangeable with other corners.

It is a further objective of the present invention to provide a corner brace for use in the constructions of enclosures and planters of significant strength and durability.

It is a further objective of the present invention to provide a corner brace for use in the construction of enclosures and planters that allows for the enclosure or planter to be constructed with a variety of materials.

Finally, it is a further objective of the invention to provide a corner brace for use in the constructions of enclosures and planters that are easy to assemble, disassemble, and transport.

### SUMMARY OF THE INVENTION

The current invention provides a corner brace for use in constructing a planter or enclosure. In the preferred embodiment of the invention the corner brace comprises a first vertical plate, second vertical plate, transverse connecting bottom plate, and a bracket-forming internal support structure. In use, each corner brace supports and restricts the ends of at least two sidewalls of a planter or enclosure. A first sidewall is supported between the first vertical plate and one side of the internal support structure. A second sidewall is supported between the second vertical plate and a second side of said internal support structure. Preferably, the sidewalls comprise a resilient yet slightly flexible material such as wood, recycled plastic lumber or similar. The bottom plate of the corner brace may comprise an anchor hole through which a stake may be threaded into the ground, further stabilizing the corner brace and keeping it from being slowly pushed away from the center of the planter by the pressure of the material therein.

### BRIEF DESCRIPTION OF THE DRAWINGS

In the attached drawings:

FIG. 1 depicts a perspective view of a planter comprising four corner braces according to a preferred embodiment of the invention;

FIG. 2 depicts a perspective view of the preferred embodiment of the invention;

FIG. 3 depicts a plan view of the preferred embodiment of the invention;

FIG. 4 depicts a bottom view of the preferred embodiment of the invention;

FIG. 5 depicts a left side view of the preferred embodiment of the invention;

FIG. 6 depicts a right side view of the preferred embodiment of the invention;

FIG. 7 depicts a second perspective view of the preferred embodiment of the invention;

FIG. 8 depicts a perspective view of an alternative embodiment of the invention;

FIG. 9 depicts a plan view of the alternative embodiment of the invention;

FIG. 10 depicts a bottom view of the alternative embodiment of the invention;

FIG. 11 depicts a right side view of the alternative embodiment of the invention;

FIG. 12 depicts a left side view of the alternative embodiment of the invention; and

FIG. 13 depicts a second perspective view of the alternative embodiment of the invention.

### DETAILED DESCRIPTION OF THE INVENTION

For purposes of this patent application, the corner brace described may be used in combination with other corner braces for creating an enclosure. In an exemplary embodiment this enclosure may be filled with soil or other suitable materials and used as a planter box. It should be readily apparent that the enclosure may be used to store myriad materials or items, such as soil, rocks, sand, organic matter, etc. but for purposes of simplicity and to describe a preferred embodiment of the invention, the term planter box or simply “planter” will be used.

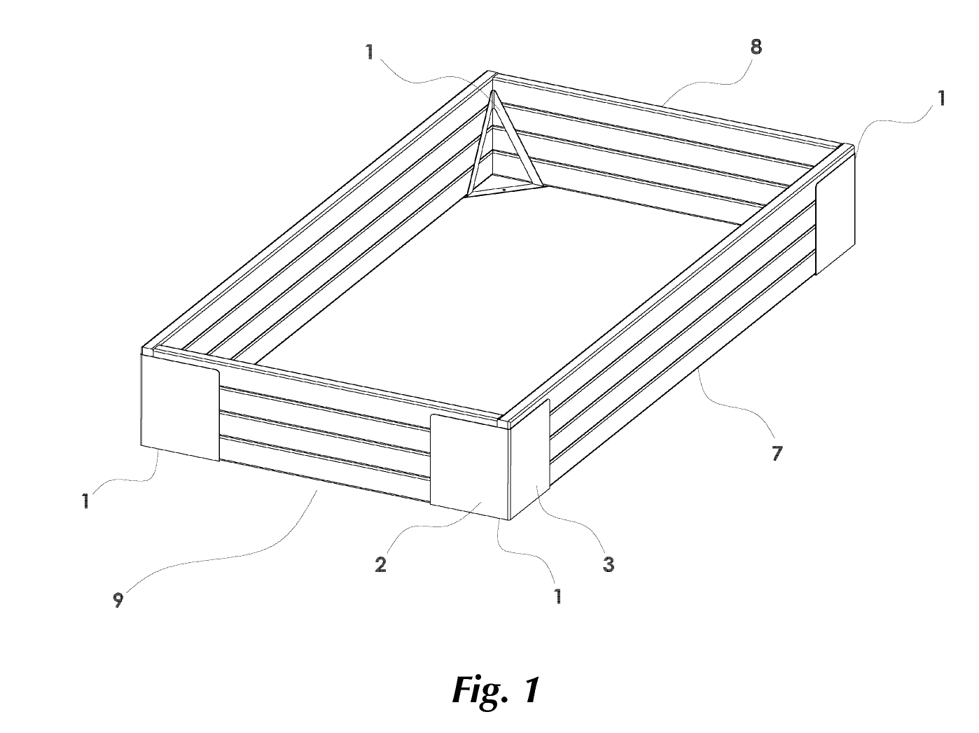

FIG. 1 depicts a preferred embodiment of the corner bracket 1 with three other similar corner brackets 1 arranged in a square enclosure formation and connected to one another by sidewall members 8, which in this exemplary embodiment are planks of wood. Although the enclosure (“planter” 9) shown here is roughly square, other rectangular shaped enclosures may be created of varying sizes simply by replacing planks on two sides with planks of longer length. Further, although four sidewall members 8 are shown stacked to make each sidewall 7, sidewalls of taller or shorter height may be readily constructed simply by modifying the dimensions of the corner brackets.

Continuing with FIG. 1, planter 9 is constructed using four corner braces 1 and four enclosure walls 7. Each enclosure wall 7 comprises one or more enclosure sidewall members 8, such as 2×4s or other similar planks of wood. Each enclosure sidewall member 8 is of the appropriate length to construct the desired size and configuration of the enclosure 9. As will be readily apparent to one of skill the art a variety of lengths of sidewall members 8 may be employed to construct an enclosure 9 of a given size and configuration. Each sidewall member 8 is supported at both ends by a corner brace 1, although the exact mechanism and means for support is not apparent from this figure.

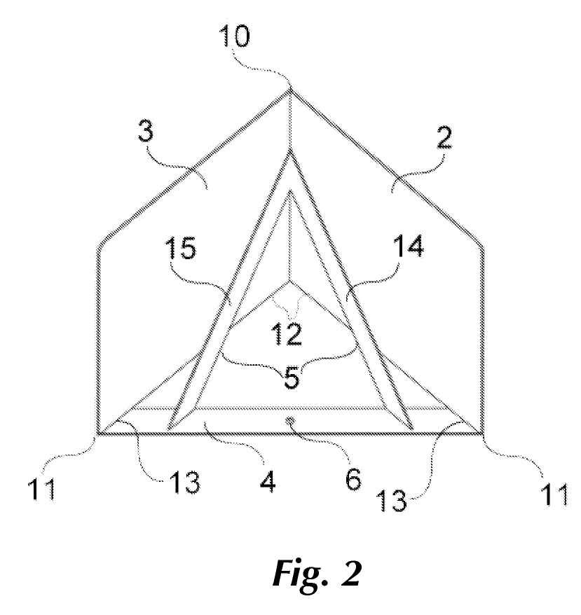

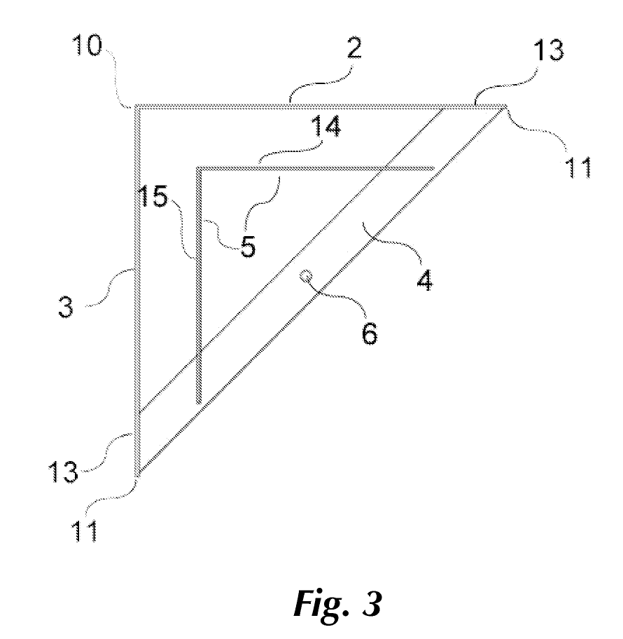

Turning to FIGS. 2 and 3, the bracket-forming internal support structure 5 is shown, as are first vertical plate 2 and second vertical plate 3. Support for the planter (not shown in these figures) is provided by slotting one of each sidewall member (not shown in these figures) between one of the two vertical plates and the internal support structure 5 of a corner brace 1. Because the sidewall members are elongate, each end is slotted into one corner brace. Thus, when forming a rectangular planter, four corner braces are used which in an exemplary and preferred embodiment provide two slots at roughly 90 degrees, each slot sized to accept one end of an elongate sidewall member.

Continuing just with FIG. 2, depicting a perspective view of the invention, it may be seen that vertical plate 2 is joined to vertical plate 3 at vertical plate intersection 10 of two adjacent vertical edges. In this preferred embodiment of the invention the angle between vertical sidewall 2 and vertical sidewall 3 is roughly ninety degrees. In other embodiments this angle may take other values ranging from almost 180 degrees to an extremely acute angle.

Joined to both vertical sidewall 2 and vertical sidewall 3 is a transverse connecting bottom plate 4. Bottom plate 4 is substantially planar, substantially horizontal and is joined to a bottom edge 12 of both vertical plates 2 and 3 at bottom intersection 13. Traverse connecting bottom plate 4 further comprises an anchor hole 6 at approximately its midpoint, which in use provides an aperture through which a stake may be threaded, thereby more securely anchoring the corner brace and thus the planter to the ground. This reduces any potential movement of the corner braces due to pressure exerted by the contents of the enclosure. The lower corner of vertical plates 2 and 3 has been designated lower corner 11 as shown.

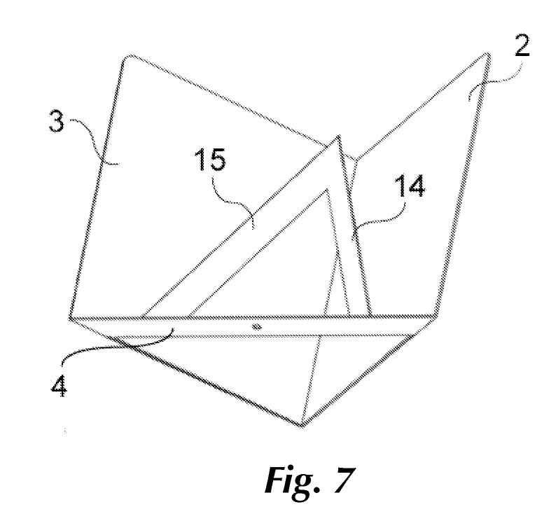

Joined to bottom plate 4 is the bracket-forming internal support structure 5. Internal support structure 5 comprises two support members 14 and 15 as labeled in FIG. 3. Support structure members 14 and 15 are each joined at a first end to bottom plate 4 and at a second end to one another other. In a preferred embodiment no other support is provided for internal support structure 5. Support structure member 14 is joined at a first end to bottom plate 4 at a distance from vertical sidewall 2 such that enclosure wall members 8 (see FIG. 1) will fit snugly between support member 14 and vertical plate 2. Similarly, support member 15 is joined to bottom plate 4 at a comparable distance from vertical sidewall 3 such that enclosure wall members will fit snugly between the two. Support members 14 and 15 each comprise a surface that is substantially planer and substantially parallel to vertical sidewalls 2 and 3, respectively. It is between these substantially planer and parallel surfaces of the support members 14 and 15 and the proximate vertical sidewalls 2 and 3 that the enclosure sidewall members 8 are supported. Support members 14 and 15 extend from their point of connection to bottom plate 4 towards vertical plate intersection 10 where they are joined to one another, as most easily understood by viewing FIGS. 2 and 7. The distance between the substantially planer surface of the support members 14 and 15 and the adjacent vertical sidewall 2 or 3 (respectively) is substantially consistent throughout the length of the support members 14 and 15.

All component parts of the corner brace 1 may be made of any appropriate material such as steel, reinforced fiber composite, or plastic. In the preferred embodiment the corner brace 1 is made of steel and the sidewall members are made of wood. Under typical strains of a four-foot wide by eight-foot long by fourteen inch high enclosure (such as that shown in FIG. 1) the steel sidewalls are found deflect less than one quarter inch. The component parts of the corner brace 1 may be joined by any means known in the art such as welding, glue, soldering, or fasteners. In the preferred embodiment the components of the corner brace 1 and joined by welding.

FIG. 3 depicts a top down view of the invention which more clearly shows that the distance between the substantially planer surface of the internal support members 14 and 15 and the adjacent vertical sidewall 2 and 3 (respectively) is consistent throughout the length of the support members 14 and 15. As can also been seen in this figure, the angle formed by support member 14 and support member 15 is in this preferred embodiment substantially equal to 90 degrees. In other embodiments this angle may take other values ranging from 180 degrees to an extremely acute angle, but in all cases the angle between support member 14 and support member 15 when viewed from above will be equal to the angle between vertical sidewall 2 and vertical sidewall 3 when viewed from above. This figure also more clearly shows the location of anchor hole 6 in bottom plate 4. In this preferred embodiment anchor hole 6 is located in the center of bottom plate 4. It will be readily apparent to those skilled in the art that any number of anchor holes or anchor means may be employed in a variety of configurations.

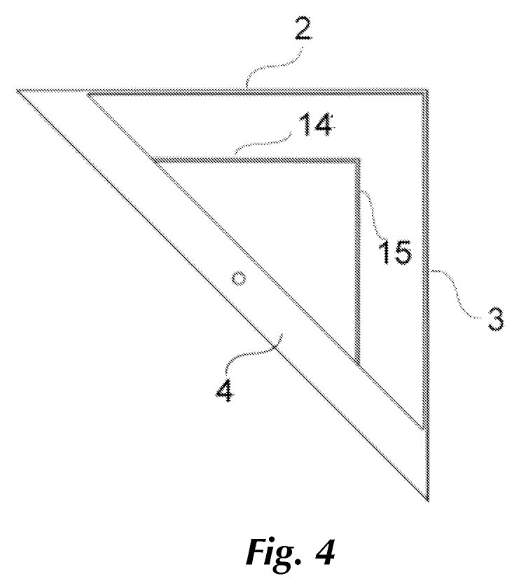

FIG. 3 also readily illustrates bottom intersection 13 of the bottom edge 12 and vertical plates 2 or 3, as well as lower corner 11. As will be apparent to one of skill in the art bottom intersection 13 may encompass only a small fraction of the total length of the bottom edge 12 of the vertical plates 2 and 3, or may encompass nearly the entire length of the bottom edge 12 of the vertical plates 2 and 3, or may encompass any fraction of the length of the bottom edge 12 of the vertical sidewalls 2 and 3 and need not necessarily encompass corner 11. FIG. 4 illustrates the underside of bottom plate 4 as well as most of the relationships between components shown in FIG. 3.

FIG. 5 depicts a left side view of the invention which shows that the distance between the substantially planer surface of the support member 15 and the adjacent vertical plate 3 is consistent throughout the length of the support member 15. This figure also illustrates how support member 14 is joined at a first end to bottom plate 4 (not labeled in this figure) and extends diagonally upwards towards an area proximate to the upper end of the corner formed by the joinder of vertical plates 2 and 3, where a second end of support member 14 is joined to a second end of support member 15.

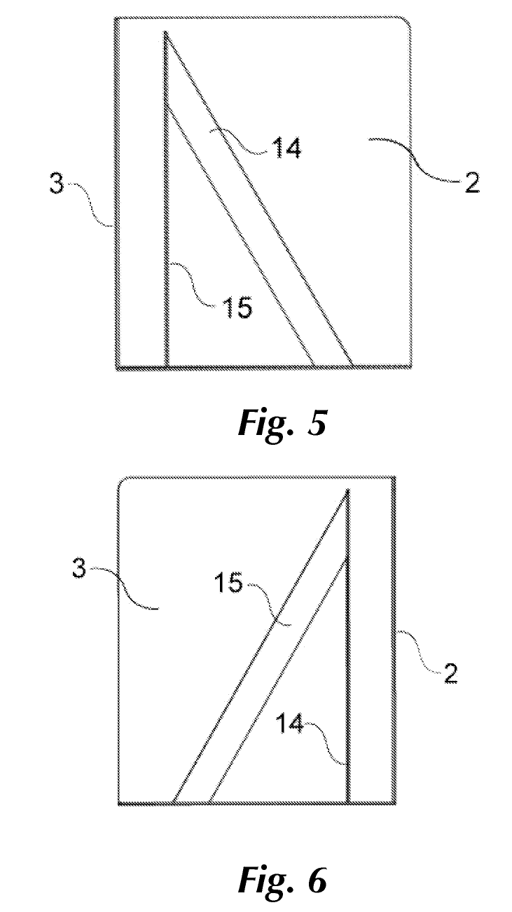

FIG. 6 depicts a right side view of the invention which shows that the distance between the substantially planer surface of the support member 14 and the adjacent vertical plate 2 is consistent throughout the length of the support member 14. This figure also illustrates how support member 15 is joined at a first end to bottom plate 4 (not labeled in this figure) and extends diagonally upwards towards an area proximate to the upper end of the corner formed by the joinder of vertical plates 2 and 3, where a second end of support member 15 is joined to a second end of support member 14.

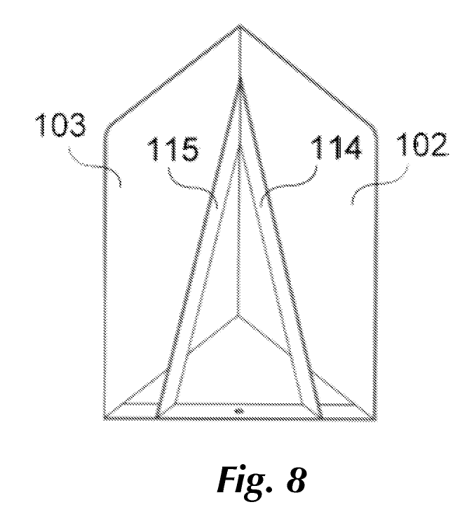

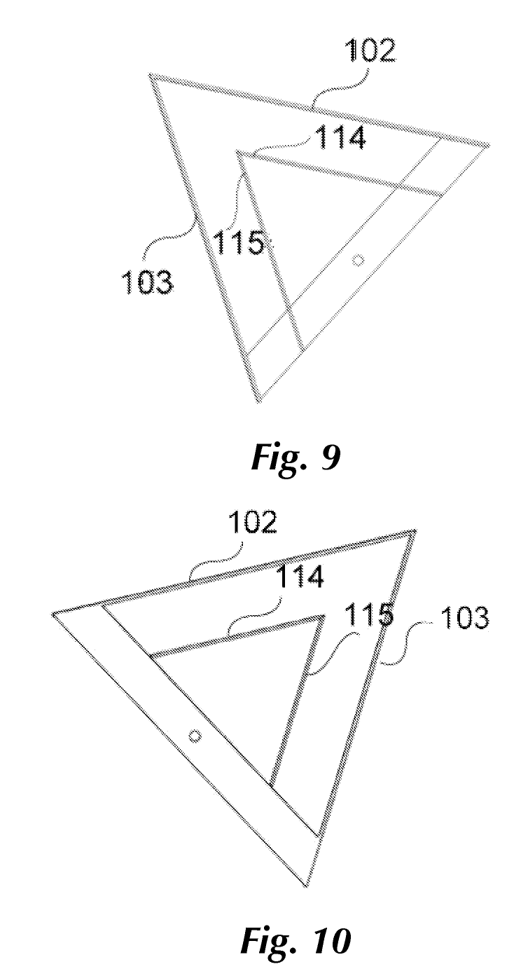

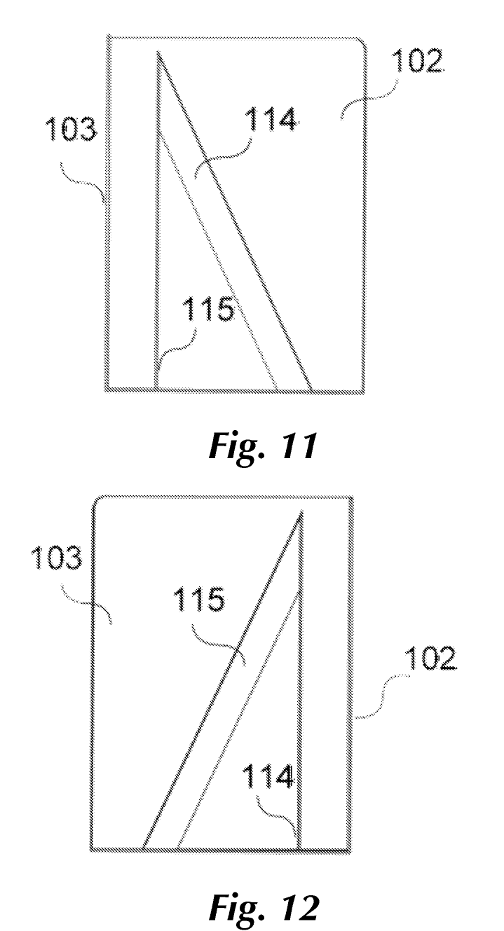

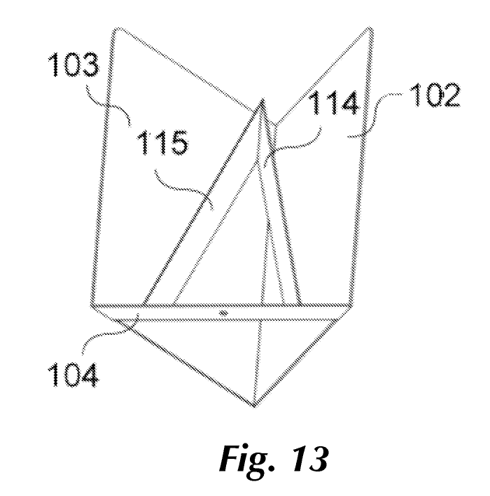

FIGS. 8 through 13 depicts an alternative embodiment of the invention in which the angle between vertical sidewall 2 and vertical sidewall 3 is approximately 60 degrees and the angle between support member 14 and support member 15 is approximately 60 degrees when viewed from above. In these figures, the alternative embodiment components corresponding to reference numbers 2, 3, 14, and 15 of the preferred embodiment have been labeled respectively as reference numbers 102, 103, 114, and 115.

As mentioned above, this alternative embodiment depicted in FIGS. 8 through 13 is one of many possible alternative embodiments. In other alternative embodiments not shown the angle between support members as well as the angle between vertical plates is between 0 and 180 degrees. In each instance the support members are planes that are substantially parallel with a corresponding vertical plate. The angle between vertical plates in each case is substantially similar to the angle between support members.

Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent) even though not structurally equivalent to the disclosed component which performs the functions in the herein exemplary embodiments of the invention. In addition, while a particular feature of the invention may have been disclosed with respect to only one embodiment, such feature may be combined with one or more other features of other embodiments as may be desired or advantageous for any given or particular application.

I claim:

1. A corner brace for an enclosure comprising:
a. a first vertical plate comprising a first vertical plate vertical edge and a first vertical plate lower edge;
b. a second vertical plate comprising a second vertical plate vertical edge and a second vertical plate lower edge, wherein said first vertical plate is joined to said second vertical plate at a first angle;
c. a transverse bottom member bridging said first vertical plate lower edge with said second vertical plate lower edge wherein the angle between each said vertical plate and said transverse bottom member is approximately 90 degrees; and
d. an internal support structure comprising a first support member substantially parallel with said first vertical plate and a second support member substantially parallel with said second vertical plate.

2. The corner brace for an enclosure according to claim 1 wherein:
a. each said support member comprises a first and second end;
b. wherein said first support member first end is joined to said transverse bottom member at a distance from said first vertical plate;
c. wherein said second support member first end is joined to said transverse bottom member at approximately said distance from said second vertical plate;
d. wherein said first support member second end is located approximately said distance from said first vertical plate; and
e. wherein said second support member second end is located approximately said distance from said second vertical plate.

3. The corner brace for an enclosure according to claim 2 wherein the first vertical plate vertical edge is at approximately a right angle in relation to said first vertical plate lower edge and wherein the second vertical plate vertical edge is at approximately a right angle in relation to said second vertical plate lower edge.

4. The corner brace for an enclosure according to claim 2 wherein said first support member second end and said second support member second end are connected to one another forming an angle approximately equal to said first angle.

5. The corner brace for an enclosure according to claim 4 wherein said first angle is between 45 and 135 degrees.

6. The corner brace for an enclosure according to claim 5 wherein said first angle is approximately 90 degrees.

7. The corner brace for an enclosure according to claim 5 wherein said first angle is approximately 60 degrees.

8. The corner brace for an enclosure according to claim 2 wherein said first support member second end is proximate to an upper edge of said first vertical plate, and said second support member second end is proximate to an upper edge of said second vertical plate.

9. The corner brace for an enclosure according to claim 8 wherein said first support member second end and said second support member second end are connected to one another forming an angle approximately equal to said first angle.

10. The corner brace for an enclosure according to claim 9 wherein said first angle is approximately 90 degrees.

11. The corner brace for an enclosure according to claim 10 wherein said transverse bottom member comprises an anchor hole.

12. An enclosure cornered by at least three identical corner braces connected thereto by an enclosure wall formed by elongate support members, the enclosure comprising:
a. at least three corner braces, each corner brace further comprising:
i. a first vertical plate comprising a vertical edge and a lower edge;
ii. a second vertical plate comprising a vertical edge and a lower edge, wherein said first vertical plate is joined to said second vertical plate at a first angle;
iii. a transverse bottom member bridging said first vertical plate lower edge with said second vertical plate lower edge wherein the angle between each said vertical plate and said transverse bottom member is approximately 90 degrees; and
iv. an internal support structure having a first support member substantially parallel with said first vertical plate and a second support member substantially parallel with said second vertical plate;
b. a number of elongate support members at least equal to said number of corner braces, and wherein each elongate support members connects two corner braces;
c. a second angle between each of said at least three corner braces, the second angle substantially similar to said first angle.

13. The enclosure according to claim 12 further wherein:
a. each said support member comprises a first and second end;
b. wherein said first support member first end is joined to said transverse bottom member a distance from said first vertical plate;
c. wherein said second support member first end is joined to said transverse bottom member at said distance from said second vertical plate;
d. wherein said first support member second end is located approximately said distance from said first vertical plate; and
e. wherein said second support member second end is located approximately said distance from said second vertical plate.

14. The enclosure according to claim 13 wherein said elongate support members have a width approximately equal to said distance.

15. The enclosure according to claim 13 wherein said first support member second end is proximate to an upper edge of said first vertical plate, and said second support member second end is proximate to an upper edge of said second vertical plate.

16. A method for constructing an enclosure in the shape of a polygon having vertices formed by corner braces, the method comprising the steps of:
a. providing at least three identical corner braces, each corner brace comprising:
i. a first vertical plate comprising a vertical edge and a lower edge;
ii. a second vertical plate comprising a vertical edge and a lower edge, wherein said first vertical plate is joined to said second vertical plate at a first angle;
iii. a transverse bottom member bridging said first vertical plate lower edge with said second vertical plate lower edge wherein the angle between each said vertical plate and said transverse bottom member is approximately 90 degrees; and
iv. an internal support structure having a first support member separated a distance from and being substantially parallel with said first vertical plate and a second support member separated said distance from and being substantially parallel with said second vertical plate;
b. providing a plurality of sidewall members having a thickness approximately equal to said distance; and
c. constructing at least three sidewalls by:
i. interposing a first end of each said sidewall member between said first vertical plate and said first support member of a first corner brace; and
ii. interposing a second end of each said sidewall member between a second vertical plate and a second support member of a second corner brace.

17. The method for constructing an enclosure according to claim 16 wherein said sidewall members are connected to one another by said corner braces at a second angle and wherein said second angle is substantially equal to said first angle.

18. The method for constructing an enclosure according to claim 17 wherein said first angle is approximately 60 degrees and wherein said polygon is a equilateral triangle.

19. The method for constructing an enclosure according to claim 18 wherein four corner braces are provided, four sidewalls are constructed, and wherein said first angle is approximately 90 degrees.

20. The method for constructing an enclosure according to claim 16 further comprising:
a. providing an anchor;
b. providing an anchor hole in said transverse bottom member; and
c. threading said anchor through said anchor hole to anchor said enclosure to the earth.
